(19) United States
(12) Patent Application Publication
(10) Pub. No.: US 2015/0029224 A1
(43) Pub. Date: Jan. 29, 2015

(54) IMAGING APPARATUS, CONTROL METHOD AND PROGRAM OF IMAGING APPARATUS, AND RECORDING MEDIUM

(71) Applicant: CANON KABUSHIKI KAISHA, Tokyo (JP)

(72) Inventors: Toshimichi Ise, Yokohama-shi (JP); Kurumi Mori, Kawasaki-shi (JP); Tomohiro Ota, Kawasaki-shi (JP); Akio Yoshikawa, Tokyo (JP); Kyota Saito, Yokohama-shi (JP)

(21) Appl. No.: 14/332,805

(22) Filed: Jul. 16, 2014

(30) Foreign Application Priority Data
Jul. 29, 2013 (JP) 2013-157007

(51) Int. Cl. G06T 3/60

(52) U.S. Cl. CPC G06T 3/60
USPC 345/649

(57) ABSTRACT

When an autorotation function is ON and an object is photographed by holding a main body in an inverse attitude, rotation units rotate a camera image by 360 degrees in total and a rotation unit rotates display OSD data by 180 degrees. A combine unit combines outputs of the rotation units and writes panel-output image data into a VRAM. A combine unit combines recording OSD data drawn by a touch drawing function to the camera image rotated by 180 degrees in the rotation unit and writes into a recording VRAM. The image data in the recording VRAM is encoded and recorded as a moving image file into a recording medium.

### BACKGROUND OF THE INVENTION

1. Field of the Invention

The present invention relates to an imaging apparatus, a control method and a program of the imaging apparatus, and a recording medium.

2. Description of the Related Art

An information apparatus having a touch panel which enables an intuitive operation is widespread and a function which brings out a merit of the touch panel is also increasing. Also in imaging apparatuses such as video camera and digital camera, there is an apparatus having a touch drawing function such as a handwriting input that can superimpose freehandedly-input characters or graphics onto an image.

On the other hand, in the imaging apparatus, there is a possibility that the photographing operation is performed while keeping an apparatus main body in various attitudes. In the case where a display of the imaging apparatus is held inversely (upside down) to a normal attitude when photographing, a display of the imaging apparatus is rotated by 180 degrees to the normal attitude (normal orientation), an OSD (On Screen Display) display on the display is inversely viewed from the user side. That is, items such as icons and the like (hereinbelow, referred to as OSD items or elements) which are displayed by the OSD are viewed as being orienting differently by 180 degrees. The OSD is such a technique that display items such as icons, information display, or the like and characters, graphics, or the like corresponding to the touch panel operation such as handwritten characters, and the like are superimposed onto a photographed image and are displayed.

In the case where a camera image which is photographed in an inverse attitude and recorded is reproduced while keeping the imaging apparatus in a normal attitude or in the case where such an image is reproduced and displayed to an external display such as a television or the like whose attitude is fixed, an object is displayed upside-down (inversely). To solve such a problem, the Official Gazette of Japanese Patent Application Laid-Open No. 2009-260521 (hereinbelow, referred to as Patent Literature 1) discloses such a technique that in the photographing which is performed while keeping the camera inversely, the photographed image is rotated by 180 degrees and recorded. Patent Literature 1 also discloses such a technique that in the photographing which is performed while keeping the camera inversely, the OSD item is rotated by 180 degrees and superimposed to the photographed image and displayed to a liquid crystal monitor.

As mentioned above, the touch drawing function (such a function that a freehandedly-input trace or a display item such as a stamp or the like is drawn to a position where a finger or pen is touched to a touch panel) is installed into the imaging apparatus using the touch panel. In the case where the display item by the touch drawing function is superimposed to the photographed image and recorded, the technique disclosed in Patent Literature 1 has the following inconvenience. That is, if the display item which is touch-drawn in a state in which the imaging apparatus is held inversely is superimposed as it is, a display item which is displayed onto the display at the time of photographing and the display item which is superimposed to the photographed image and recorded are displayed inversely (180-degree rotation). Consequently, a user's intended effect of the touch drawing cannot be realized.

### SUMMARY OF THE INVENTION

Therefore, it is an aspect of the invention to provide an imaging apparatus which enables the touch drawing function to be effectively used, a control method and a program of the imaging apparatus, and a recording medium.

According to an aspect of the invention, an imaging apparatus comprises: an imaging unit; a display unit; a position input unit configured to input a position to the display unit; a drawing unit configured to draw a recording object on the basis of the position on a screen of the display unit input by the position input unit; an attitude detection unit configured to detect an attitude of the imaging apparatus; a storing unit configured to store a display item; and a control unit configured to control in such a manner that when the attitude detection unit detects an inverse attitude of the imaging apparatus, an image photographed by the imaging unit and the recording object which is input by the position input unit are displayed to the display unit in a same orientation and the display item is displayed in an orientation opposite to an orientation in which the display item is stored in the storing unit, and the image photographed by the imaging unit and the recording object which is input by the position input unit are combined and recorded to a recording medium so that the combined image and object are oriented inversely each other.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram of a schematic construction of an embodiment of the invention.

FIGS. 2A, 2B and 2C are diagrams of examples of attitudes in the embodiment.

FIGS. 3A, 3B and 3C are diagrams of examples of the attitude, object, and display image of an LCD panel in the embodiment.

FIG. 4A is a diagram of an example of an image and an image processing in the case of a normal attitude in the embodiment.

FIG. 4B is a diagram of an example of an image and an image processing in the case of an inverse attitude in a related art.

FIG. 5 is a diagram of an example of an image and an image processing in the case of an inverse attitude in the embodiment.

FIG. 6 is a diagram of another example of an image and an image processing in the case of the inverse attitude in the embodiment.

FIG. 7 is a diagram of an example of processings of a rotation and a combination in the case of the inverse attitude in the embodiment.

FIG. 8 is a diagram of another example of processings of a rotation and a combination in the case of the inverse attitude in the embodiment.

FIG. 9 is a flowchart for the operation in the embodiment.

FIG. 10 is a flowchart for the operation of a touch drawing function in the embodiment.

FIG. 11 is a diagram of still another example of processings of a rotation and a combination in the case of the inverse attitude in the embodiment.

### DESCRIPTION OF THE EMBODIMENTS

Various exemplary embodiments, features, and aspects of the present invention will be described in detail below with reference to the drawings.

### First Embodiment

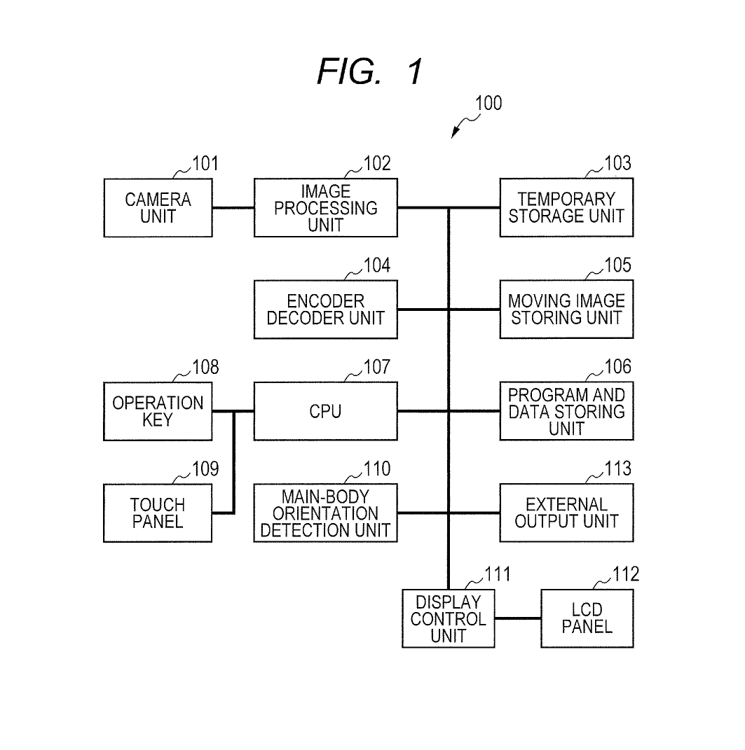

FIG. 1 is a block diagram of a schematic construction of a digital video camera as an embodiment of an imaging apparatus according to the invention. A digital video camera (hereinbelow, abbreviated to a camera) 100 has a touch drawing function which can superimpose graphics and characters drawn by the user to a recording image. The touch drawing function has a pen, a stamp, an eraser, an animation, and the like as types of handwriting input (touch drawing).

A CPU 107 of the camera 100 reads out a control program from a program and data storing unit 106 and controls the whole operation of the camera 100. The CPU 107 can execute, in parallel, a plurality of tasks of the control program which is read out from the program and data storing unit 106. Specifically speaking, a mode control task, a camera control task, a recorder control task, and a display control task operate in parallel on the CPU 107. The CPU 107 which executes the display control task plays a function as a display control unit.

A temporary storage unit 103 is a RAM which functions not only as a work area of the CPU 107 but also as a moving-image frame buffer and a frame buffer for OSD (On Screen Display). Display items which have previously been stored in the program and data storing unit 106 are called OSD data or OSD items so as to be distinguished from a photographed image obtained through image pickup by a camera unit 101. Various kinds of information for menu, icons, touch icons, and the like are included in the OSD data.

The camera unit 101 is a unit for inputting an analog image signal to the camera 100. Specifically speaking, the camera unit 101 includes a photographing lens for focusing light from an object, an imaging element for photoelectrically converting the object image focused by the photographing lens, a circuit for driving the imaging element, and the like. An image processing unit 102 converts the analog image signal which is input from the camera unit 101 into digital moving image data and makes a correction based on a predetermined image processing such as noise removal or the like. The camera control task which is executed by the CPU 107 controls those operations of the camera unit 101 and the image processing unit 102.

An encoder decoder unit 104 comprises: an encoder for encoding the moving image data from the image processing unit 102; and a decoder for decoding the encoded moving image data. The moving image data encoded by the encoder decoder unit 104 is temporarily stored into the temporary storage unit 103 and, thereafter, is stored into a moving image storing unit 105 together with management data related thereto. The moving image storing unit 105 comprises a detachable memory card, a hard disk or flash memory serving as an internal recording medium, or the like. On the contrary, when a moving image is reproduced, the encoded moving image data which is read out from the moving image storing unit 105 is supplied to the encoder decoder unit 104 through the temporary storage unit 103 and is decoded. The encoder decoder unit 104 develops the reproduction image data obtained by the decoding into a moving image frame buffer in the temporary storage unit 103. The recorder control task which is executed by the CPU 107 controls those operations of the encoder decoder unit 104 and the moving image storing unit 105.

The management data which is read out from the moving image storing unit 105 is used to generate the OSD data, that is, a character display or data for GUI (Graphical User Interface) which is superimposed to the photographed image or reproduction image. The CPU 107 draws the generated OSD data into an OSD frame buffer (VRAM) in the temporary storage unit 103. The contents in each of the moving image frame buffer and the OSD frame buffer are superimposed by a display control unit 111 and displayed to an LCD panel 112.

Each of an operation key 108 and a touch panel 109 is an operation unit for receiving an operation instruction from the user. The touch panel 109 is arranged so as to be overlaid on a display screen of the LCD panel 112. For example, the touch panel 109 is constructed so that transmissivity does not affect to display of the LCD panel 112. The touch panel 109 is attached to an upper one of layers disposed on the display surface of the LCD panel 112. By making input coordinates on the touch panel 109 and display coordinates on the LCD panel 112 correspond to each other, a GUI can be constructed as if the user directly operated the image displayed on the LCD panel 112. As a type of touch panel 109, there are various types such as resistance film type, electric capacity type, surface acoustic wave type, infrared-ray type, electromagnetic induction type, image recognition type, photo sensor type, and the like. In the embodiment, any one of those types may be used.

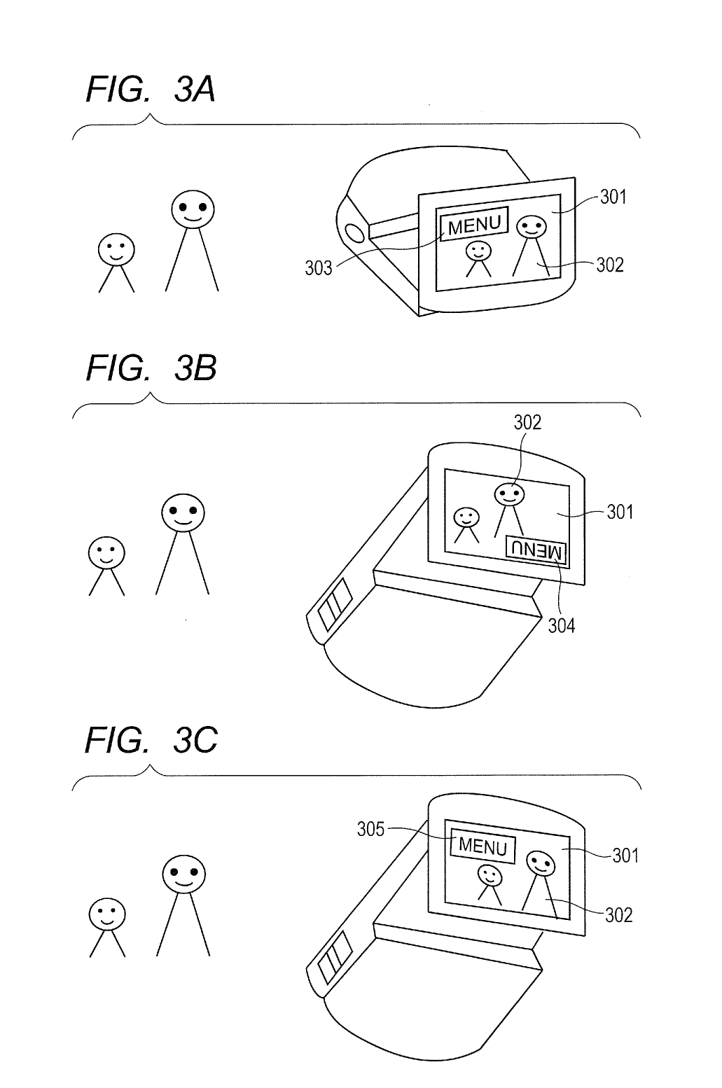

A main-body orientation detection unit 110 is a unit for detecting an orientation (or its change) of the camera main body. By the main-body orientation detection unit 110, the CPU 107 can determine whether the camera is in a state in which the user inversely holds the camera 100 (for example, FIG. 3B) or a state in which the user normally holds the camera 100 (for example, FIG. 3A). The main-body orientation detection unit 110 is constructed by an acceleration sensor, a gyro sensor, or the like which can detect a gravitational direction.

An external output unit 113 is an interface for outputting a camera image photographed by the camera unit 101 and a reproduction image which is read out from the moving image storing unit 105 and is reproduced onto an external monitor such as a television or the like. It is not always necessary to provide the external output unit 113.

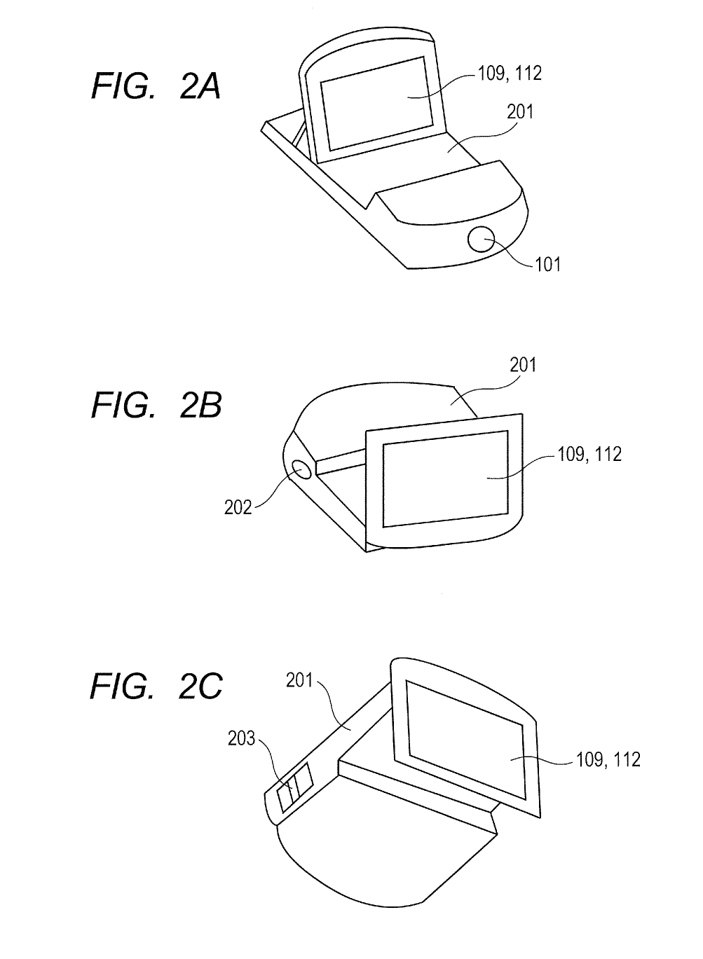

FIGS. 2A to 2C illustrate external views at each attitude of the camera 100. FIG. 2A illustrates the external view of the camera 100 at a position where the screen of the LCD panel 112 can be viewed from the object side in the normal attitude state. FIG. 2B illustrates the external view of the camera 100 at a position where the screen of the LCD panel 112 can be viewed from the side opposite to the object in the normal attitude state. FIG. 2C illustrates the external view of the camera 100 at a position where the screen of the LCD panel 112 can be viewed from the side opposite to the object in the inverse attitude state (i.e., the camera 100 is held upside-down).

As illustrated in FIGS. 2A to 2C, the camera unit 101 is arranged on the side edge surface of a camera main body 201 and the LCD panel 112 is arranged on the upper surface of the camera main body 201 so that the display screen can be changed to the object side and the side opposite thereto. As illustrated in FIG. 2B, as a part of the operation key 108, a shutter button 202 is attached to the side surface of the camera main body 201. By pressing the shutter button 202, the user can record a still image at arbitrary timing. As illustrated in FIG. 2C, as a part of the operation key 108, a lens cover slide switch 203 is attached to the side surface of the camera main body 201. By slidingly moving the lens cover slide switch 203, the user can open and close a lens cover for protecting a photographing lens of the camera unit 101.

The CPU 107 can detect the following operation to the touch panel 109 or a state thereof. Such an operation that the touch panel 109 is touched by a finger or pen is hereinbelow referred to as (Touch-Down). A state in which a finger or pen is in touch with the touch panel 109 is hereinbelow referred to as (Touch-On). Such an operation that a finger or pen is moved while keeping in touch with the touch panel 109 is hereinbelow referred to as (Touch-Move). Such an operation that a finger or pen which is in touch with the touch panel 109 is detached is hereinbelow referred to as (Touch-Up). A state in which nothing is in touch with the touch panel 109 is detached is hereinbelow referred to as (Touch-Off).

Those operations/states to the touch panel 109 and coordinates of the position where a finger or pen is in touch with the touch panel 109 are notified to the CPU 107 through an internal bus. On the basis of those information notified from the touch panel 109, the CPU 107 discriminates the operation to the touch panel 109. That is, the CPU 107 functions as a touch detection unit for detecting the touch operation to the touch panel 109.

As for Touch-Move, also with respect to the moving direction of the finger or pen which moves on the touch panel 109, the CPU 107 can discriminate a vertical component and a horizontal component on the touch panel 109 on the basis of a change in position coordinates. When Touch-Up is performed from Touch-Down on the touch panel 109 through predetermined Touch-Move, the finger or pen is discriminated by the CPU 107 to have drawn a stroke. Such an operation that the finger draws quickly the stroke is referred to as a “flick”. The flick is such an operation that the finger is quickly moved by some extent of distance on the touch panel 109 while keeping the touch with the touch panel 109 and then is merely detached. In other words, it is such an operation that the finger quickly rubs the touch panel 109 as if it is flipped by the finger. When it is detected that Touch-Move is performed by a predetermined distance or longer at a predetermined speed or higher and Touch-Up is detected as it is, the CPU 107 determines that the flick is performed. When it is detected that Touch-Move is performed by a predetermined distance or longer at the predetermined speed or lower, the CPU 107 determines that a drag is performed.

The mode control task which is executed by the CPU 107 shifts an operation state of the camera 100 in accordance with an instruction from the operation unit (operation key 108, touch panel 109), a request from another task, or a change in internal state which is managed by the mode control task itself. The mode control task notifies the related task of the operation state shift as a task event in accordance with necessity.

The camera 100 has: an operation mode for automatically controlling a position and an orientation of the OSD item on the LCD panel 112 in accordance with the attitude of the camera 100; and an operation mode for displaying the OSD item at predetermined position and orientation without depending on the attitude. By turning on an autorotation function, the former operation mode is set. By turning off the autorotation function, the latter operation mode is set. When the autorotation function is ON, the image photographed by the camera unit 101 is recorded as it is into the moving image storing unit 105 or is rotated by 180 degrees and recorded therein in accordance with whether the attitude of the camera main body which is discriminated on the basis of a detection result of the main-body orientation detection unit 110 is a normal attitude or an inverse attitude (i.e., the camera 100 is held upside-down). That is, when the camera is in the normal attitude, the image photographed by the camera unit 101 is recorded into the moving image storing unit 105 while keeping its orientation as it is. However, when the camera is held upside-down, the image is rotated by 180 degrees and recorded into the moving image storing unit 105.

FIGS. 3A to 3C illustrate a correspondence relation between the attitude of the camera 100 and the display image on the LCD panel 112. FIG. 3A illustrates an example of a display screen of the LCD panel 112 in the case where the object is photographed at the normal attitude and the photographer uses the LCD panel 112 as a view finder. FIG. 3B illustrates an example of the image which is displayed to the LCD panel 112 in the case where the autorotation function is OFF and the orientation of the camera main body is upside-down. FIG. 3C illustrates an example of the image which is displayed to the LCD panel 112 in the case where the autorotation function is ON and the orientation of the camera main body is upside-down. In any of those cases, the image within the photographing field of the camera unit 101 is displayed on the whole screen of the LCD panel 112.

In the case of the normal attitude illustrated in FIG. 3A, an object 302 is displayed erectly on the screen of the LCD panel 112 and a menu button 303 serving as a touch button showing that the touch operation can be performed is displayed in an upper left portion of the display screen by the OSD.

In the case of FIG. 3B where the autorotation function is OFF and the orientation of the camera is upside-down, the object 302 is displayed erectly on the display screen of the LCD panel 112. A menu button 304 serving as a touch button showing that the touch operation can be performed is inversely (that is, such an orientation that an upper portion in the gravitational direction is set to a lower portion of the menu button 304) displayed in a lower right portion of the display screen by the OSD. In other words, the menu button 304 is displayed at the same position in the same direction as those in the case of the normal attitude.

In the case of FIG. 3C where the autorotation function is ON and the orientation of the camera is upside-down, the object 302 is displayed erectly on the display screen of the LCD panel 112. A menu button 305 serving as a touch button showing that the touch operation can be performed is displayed in an upper left portion of the display screen by the OSD. Unlike the menu button 304 illustrated in FIG. 3B, the menu button 305 is displayed in the correct direction when viewed from the user (that is, such an orientation that the upper portion in the gravitational direction is set to an upper portion of the menu button 305).

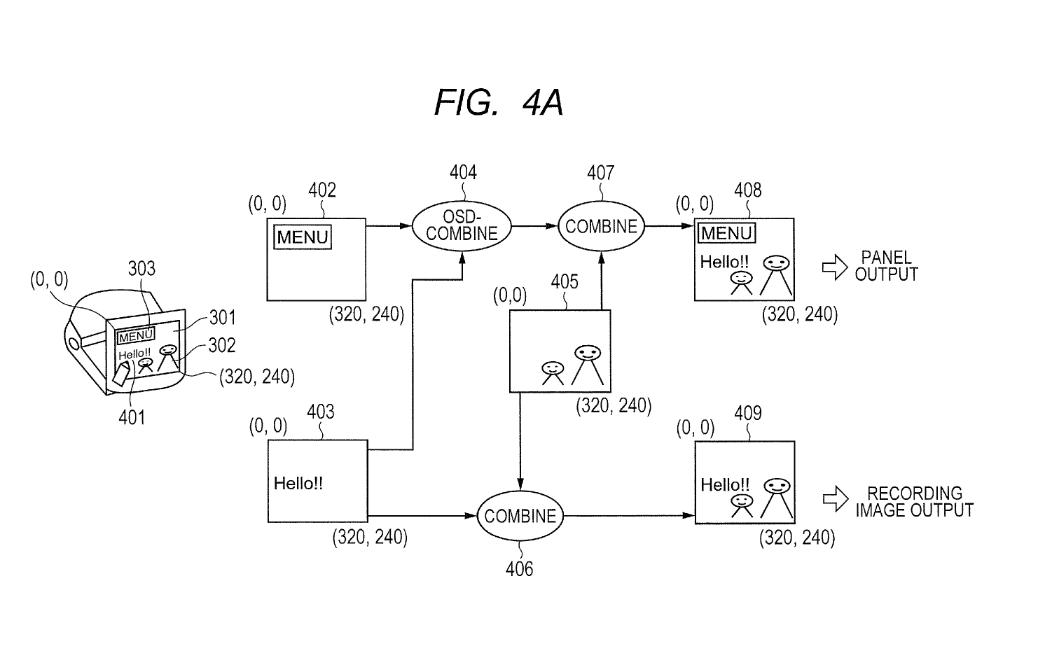

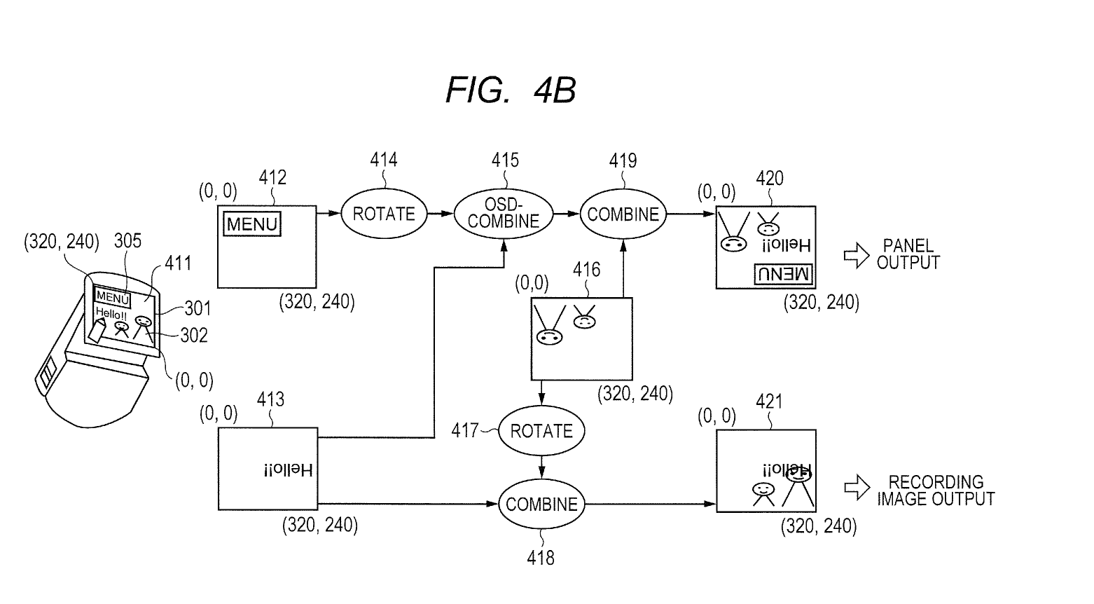

FIGS. 4A and 4B are schematic diagrams illustrating relations among an orientation of the image signal and a position and an orientation of the OSD data in the case where the autorotation function is ON. FIG. 4A illustrates the schematic diagram of a signal path in the case of the normal attitude. FIG. 4B is a diagram which is used for comparison with the embodiment and illustrates a schematic diagram of a signal path in the case where the camera to which the technique disclosed in Patent Literature 1 is applied is held upside-down.

In any of FIGS. 4A and 4B, the image within the photographing field of the camera unit 101 is displayed on the whole screen of the LCD panel and the object 302 is displayed. The menu buttons 303 and 305 serving as touch buttons are displayed in the upper left portion of the display screen by the OSD. In this description example, upper left coordinates of the LCD panel and the touch panel in the normal attitude are assumed to be (0, 0) and lower right coordinates are assumed to be (320, 240). It is now assumed that the user drew characters 401 and 411 of “Hello!!” to lower side portions of the menu buttons 303 and 305 by free-hand as one of the touch drawing function.

In the example illustrated in FIG. 4A, since the camera is in the normal attitude, “Hello!!” is written like image data 403 in an erect state into a buffer memory of the touch drawing function. On the other hand, in the example illustrated in FIG. 4B, since the camera is in the inverse attitude, “Hello!!” is written like image data 413 in an upside-down state into the buffer memory of the touch drawing function. It is now assumed that the upper left coordinates of the LCD panel and the touch panel in the normal attitude are assumed to be the origin (0, 0) and the lower right coordinates are assumed to be (320, 240).

Upper left coordinates of the image data 403 and 413 are (0, 0) and lower right coordinates are (320, 240). Upper left coordinates of image data 402 and 412 corresponding to the OSD data are (0, 0) and lower right coordinates are (320, 240). Handwritten characters or the like which were input by the touch drawing function are superimposed to the camera image and can be recorded to the recording medium.

Image data 402, 403, 405, 408, and 409 in FIG. 4A are data obtained by visualizing the contents of the image data which is developed in the temporary storage unit 103 by the CPU 107.

The image data 402 is display OSD data and is updated at timing when the display screen is shifted and in the case where there is a change in internal state. The display OSD data is used only for the purpose of displaying information upon photographing and is not included in the recording image to be recorded into the moving image storing unit 105. In the photographing mode, since the CPU 107 displays the menu button 303 to the upper left portion of the display screen, the menu button is drawn in the upper left portion of the image data 402.

The image data 403 is recording OSD data which can include handwritten graphics or the like and is superimposed to the image photographed by the camera unit 101 and is recorded into the moving image storing unit 105. When the touch drawing function is used, the image data 403 is updated in the case where the user performed the free-hand input/stamp input. In the example illustrated in FIG. 4A, since the characters of “Hello!!” are input by the touch drawing function, the character image of “Hello!!” is drawn in the left center portion (handwriting position) of the image data 403.

The image data 405 is an image which is picked up by the camera unit 101 and the object 302 is displayed on the screen. A combine unit 406 combines the image data 405 and the image data 403 and generates the recording image data 409 (recording image). The encoder decoder unit 104 encodes the image data 409 and records the encoded image data into the moving image storing unit 105.

An OSD-combine unit 404 combines the image data 402 (display OSD data) and the image data 403 (recording OSD data) and generates the OSD data for displaying to the LCD panel (for outputting to the outside). A combine unit 407 combines the image data 405 (photographed image data) to the output image data of the OSD-combine unit 404 and generates the image data 408 for displaying to the panel. The image data 408 is an image in which the menu button 303 for OSD display and the characters 401 of “Hello!!” of the OSD for superimposing are combined to the photographed image. The image data 408 is supplied to the LCD panel 112 and displayed as an image.

Image data 412, 413, 416, 420, and 421 in FIG. 4B correspond to the image data 402, 403, 405, 408, and 409 in FIG. 4A as an image processing procedure, respectively.

The image data 412 is display OSD data and is updated at timing when the display screen is shifted and in the case where there is a change in internal state. In the photographing mode, since the menu button 305 is displayed to the upper left portion of the display screen, the menu button is drawn in the upper left portion of the image data 412.

The image data 413 is recording OSD data which can include handwritten graphics or the like and is superimposed to the photographed image and is recorded into a moving image storing unit (corresponding to the moving image storing unit 105). When the touch drawing function is used, the image data 413 is updated in the case where the user performed the free-hand input/stamp input. In the example illustrated in FIG. 4B, the characters of “Hello!!” are input by the touch drawing function. In this description example, since the camera is held upside-down, in the image data 413, the inverse character image of “Hello!!” is drawn in the left center portion.

The image data 416 is an image which is picked up by the camera unit so that there exists the object 302 of the inverse state in the image on the screen. The reason why the object is inversely displayed is that since the camera is held upside-down, the output image signal of the camera unit is also inversed. An image rotation unit 417 rotates the image data 416 by 180 degrees. A combine unit 418 combines the image data 413 to the output image data of the image rotation unit 417 and generates the recording image data 421 (recording image). An encoder decoder unit corresponding to the encoder decoder unit 104 encodes the image data 421 and records the encoded image data into the moving image storing unit.

An image rotation unit 414 rotates the image data 412 (display OSD data) by 180 degrees. An OSD-combine unit 415 combines the output image data 402 of the image rotation unit 414 and the image data 413 (recording OSD data) and generates the OSD data for displaying to the LCD panel (for outputting to the outside). A combine unit 419 combines the image data 416 (photographed image data) to the output image data of the OSD-combine unit 415 and generates the image data 420 for displaying to the panel. The image data 420 is an image in which the menu button 305 for OSD display and the characters 411 of “Hello!!” of the OSD for superimposing are combined to the photographed image. The image data 420 is in a state where it is rotated by 180 degrees. Since the user inversely holds the camera and inversely watches an LCD monitor corresponding to the LCD panel 112, the object 302 is viewed in the correct orientation (the same orientation as that of the object in the real world).

As described with reference to FIG. 4B, the images (recording OSD, display OSD, object) which are displayed to the LCD panel and the camera image (orientation of the object) which are recorded to the recording medium satisfy the user's desire. However, the recording OSD (characters of “Hello!!”) is an image which is rotated by 180 degrees and this image differs from the image which is input by the touch drawing function and is displayed to the LCD panel. Therefore, the recording image (image data 421) to which the recording OSD is superimposed does not satisfy the user's desire. The embodiment solves such an inconvenience.

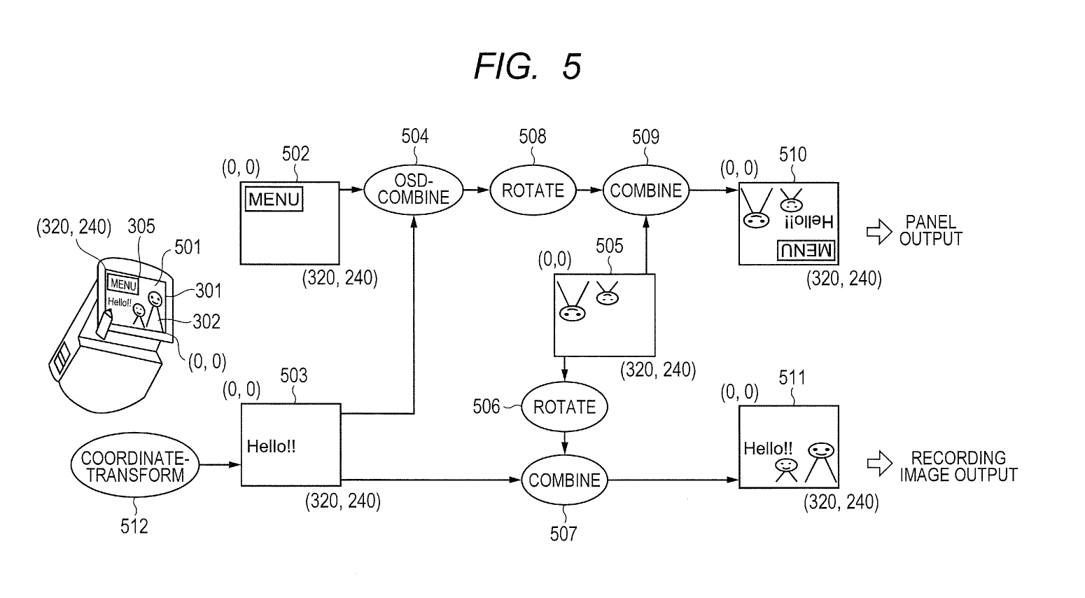

FIG. 5 illustrates a schematic diagram of an image processing in the case of inversely holding the camera 100 in which the autorotation function is ON. The image within the photographing field of the camera unit 101 is displayed on the whole screen of the LCD panel 112 and the object 302 is displayed. The menu button 305 serving as a touch button is displayed in an upper left portion of the display screen by the OSD. Also in this description example, the upper left coordinates of the LCD panel and the touch panel in the normal attitude are assumed to be (0, 0) and the lower right coordinates are assumed to be (320, 240). It is now assumed that the user drew characters 501 of “Hello!!” to a lower side portion of the menu button 305 by free-hand as one of the touch drawing function.

Image data 502, 503, 505, 510, and 511 in FIG. 5 are data obtained by visualizing the contents of the image data which is developed in the temporary storage unit 103 by the CPU 107.

The image data 502 is display OSD data and is updated at timing when the display screen is shifted and in the case where there is a change in internal state. In the photographing mode, since the menu button 305 is displayed to the upper left portion of the display screen, the menu button is drawn in the upper left portion of the image data 502.

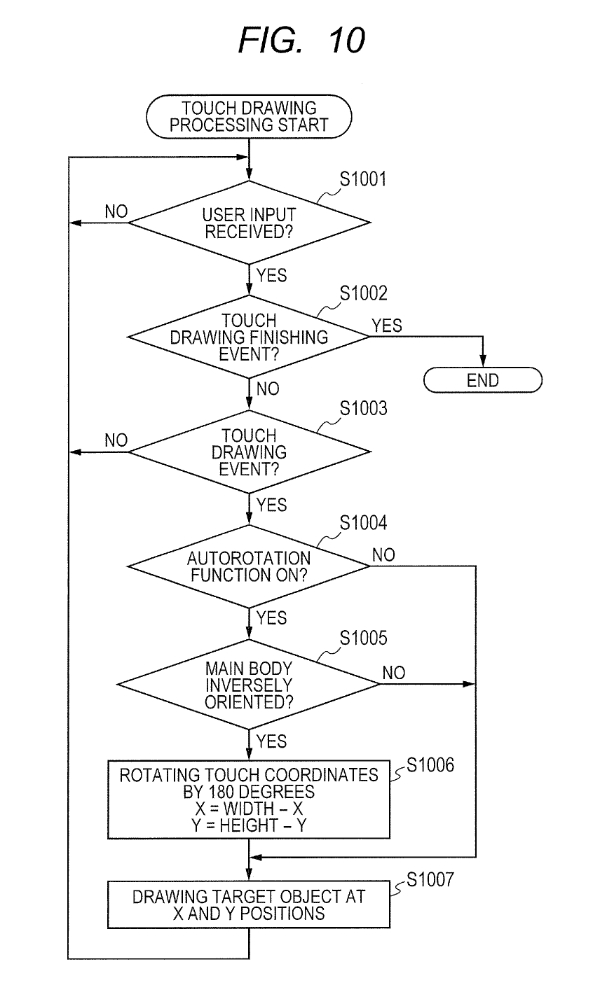

The image data 503 is recording OSD data which can include handwritten graphics or the like and is superimposed to the photographed image and is recorded into the moving image storing unit 105. When the touch drawing function is used, the image data 503 is updated in the case where the user performs the free-hand input/stamp input. In the example illustrated in FIG. 5, the characters of “Hello!!” are input by the touch drawing function. Since a coordinate-transform unit 512 rotates the item which is input by the touch drawing function by 180 degrees, in spite of a fact that the camera 100 is held upside-down, in the image data 503, the character image of “Hello!!” is drawn in the right center portion in an erect state. Specifically speaking, the coordinate-transform unit 512 rotates the item which is input-instructed by free-hand to the coordinates (320, 240) by 180 degrees and draws at a position corresponding to the coordinates (0, 0) of the image data 503. An obtaining (generating) method of the image data 503 by the touch drawing function will be described hereinafter with reference to FIG. 10.

The image data 505 is an image which is picked up by the camera unit 101 so that there exists the object 302 of the inverse state in the image on the screen. The reason why the object is displayed in the inverse state is that since the camera 100 is held upside-down, the output image signal of the camera unit 101 is also inversed. An image rotation unit 506 rotates the image data 505 by 180 degrees. A combine unit 507 combines the image data 503 to output image data of the image rotation unit 506 and generates the recording image data 511 (recording image). The encoder decoder unit 104 encodes the image data 511 and records the encoded image data into the moving image storing unit 105.

An OSD-combine unit 504 combines the image data 502 (display OSD data) and the image data 503 (recording OSD data). An image rotation unit 508 rotates output image data of the OSD-combine unit 504 by 180 degrees. Output image data of the image rotation unit 508 is OSD data for displaying to the LCD panel (for outputting to the outside). A combine unit 509 combines the image data 505 (photographed image data) to the output image data of the image rotation unit 508 and generates the image data 510 for displaying to the panel. The image data 510 is an image in which the menu button 305 for OSD display and the characters 501 of “Hello!!” of the OSD for superimposing are combined to the photographed image. Although the object 302 is displayed in the inverse state in the image data 510, since the user inversely holds the camera and watches the LCD panel 112 in the inverse state, the object 302 is viewed in the correct orientation (the same orientation as that of the object in the real world).

As illustrated in FIG. 5, when the camera 100 is held in the inverse state, the image data which is displayed to the LCD panel 112 is in a state where it is rotated by 180 degrees. On the other hand, the recording image (image data 511) to be recorded into the moving image storing unit 105 is an image which is viewed as it is by the user (image in which the recording OSD and the photographed image are combined in the same position and direction as those upon photographing). That is, the image which is viewed by the user on the display screen of the LCD panel 112 at the time of photographing and the recording image include the recording OSD, so that they are identical. Also as a reproduction image, the same image as the image displayed on the LCD panel 112 at the time of photographing can be reproduced.

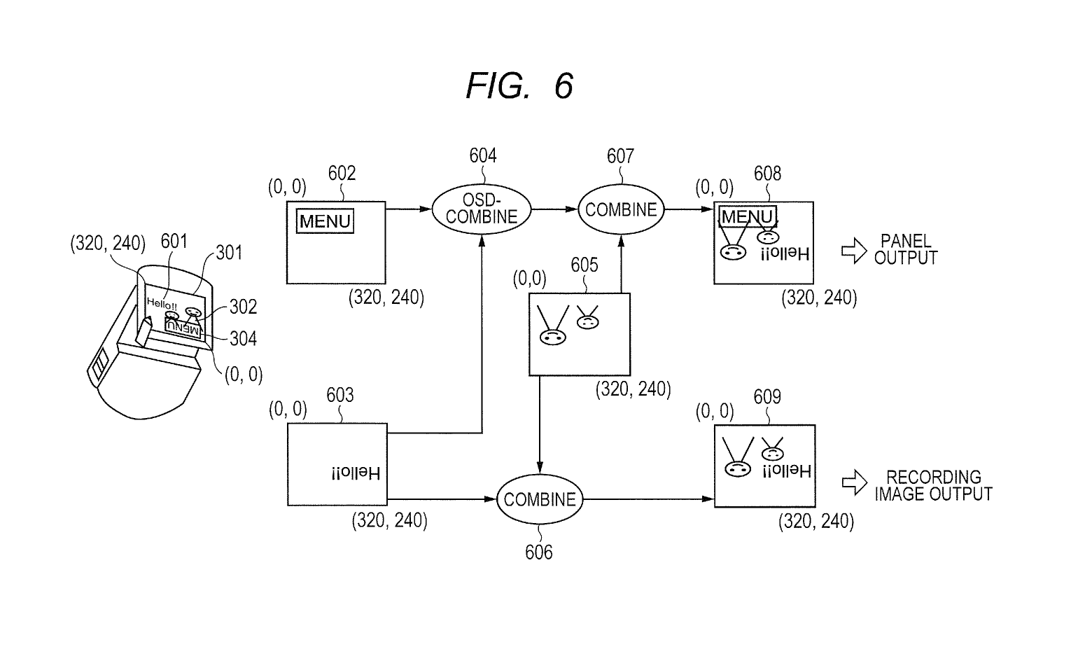

FIG. 6 illustrates a schematic diagram of an image processing in the case of inversely holding the camera 100 in which the autorotation function is OFF. Since the autorotation function is set to OFF, the control for rotating the OSD data and the output image data from the camera unit 101 is OFF. The image within the photographing field of the camera unit 101 is displayed on the whole screen of the LCD panel 112 and the object 302 is displayed. The menu button 304 serving as a touch button is displayed in a lower right portion of the display screen by the OSD. Also in this description example, the upper left coordinates of the LCD panel and the touch panel in the normal attitude are assumed to be (0, 0) and the lower right coordinates are assumed to be (320, 240). It is now assumed that the user drew characters 601 of “Hello!!” to a left center portion of the inverted LCD panel 112 by free-hand as one of the touch drawing function.

Image data 602, 603, 605, 608, and 609 in FIG. 6 are data obtained by visualizing the contents of the image data which is developed in the temporary storage unit 103 by the CPU 107.

The image data 602 is display OSD data and is updated at timing when the display screen is shifted and in the case where there is a change in internal state. In the photographing mode, since the menu button 304 is displayed on the display screen of the LCD panel 112 in the same position and orientation as those in the case of the normal attitude, the menu button is drawn in the upper left portion of the image data 602.

The image data 603 is recording OSD data which can include handwritten graphics or the like and is superimposed to the photographed image and is recorded into the moving image storing unit 105. When the touch drawing function is used, the image data 603 is updated in the case where the user performs the free-hand input/stamp input. In the example illustrated in FIG. 5, the characters of “Hello!!” are input by the touch drawing function. Since a coordinate-transform unit 512 rotates the item which is input by the touch drawing function by 180 degrees, in spite of a fact that the camera 100 is held upside-down, in the image data 503, the character image of “Hello!!” is drawn in the right center portion in an erect state. Specifically speaking, the coordinate-transform unit 512 rotates the item which is input-instructed by free-hand to the coordinates (320, 240) by 180 degrees and draws at a position corresponding to the coordinates (0, 0) of the image data 503. An obtaining (generating) method of the image data 503 by the touch drawing function will be described hereinafter with reference to FIG. 10.

The image data 603 is recording OSD data which can include handwritten graphics or the like and is superimposed to the photographed image and is recorded into the moving image storing unit 105. When the touch drawing function is used, the image data 603 is updated in the case where the user performs the free-hand input/stamp input. In the example illustrated in FIG. 6, the characters of “Hello!!” are input in the left center portion of the display screen by the touch drawing function. Since the camera 100 is inversely held, in the image data 603, the character image of “Hello!!” is drawn in the right center portion in an upside-down state.

The image data 605 is an image which is picked up by the camera unit 101 so that there exists the object 302 of the inverse state in the image on the screen. The reason why the object is displayed in the inverse state is that since the camera 100 is held upside-down, the output image signal of the camera unit 101 is also inversed. A combine unit 606 combines the image data 603 to the image data 605 and generates the recording image data 609 (recording image). The encoder decoder unit 104 encodes the image data 609 and records the encoded image data into the moving image storing unit 105.

An OSD-combine unit 604 combines the image data 602 (display OSD data) and the image data 603 (recording OSD data). A combine unit 607 combines the image data 605 (photographed image data) to output image data of the OSD-combine unit 604 and generates the image data 608 for panel display. The image data 608 is an image in which the menu button 304 for OSD display and the characters 601 of “Hello!!” of OSD for superimposing are combined to the photographed image. Although the object 302 is displayed in the inverse state in the image data 608, since the user inversely holds the camera and inversely watches the LCD panel 112, the object 302 is viewed in the correct orientation (the same orientation as that of the object in the real world).

As illustrated in FIG. 6, when the autorotation function is OFF and the camera 100 is held in the inverse state, with exception of the display OSD data, the image data 609 having the same contents as those of the image data 608 which is displayed to the LCD panel 112 is recorded into the moving image storing unit 105. That is, the image which is viewed by the user on the display screen of the LCD panel 112 at the time of photographing and the recording image are identical while including the position and orientation of the recording OSD.

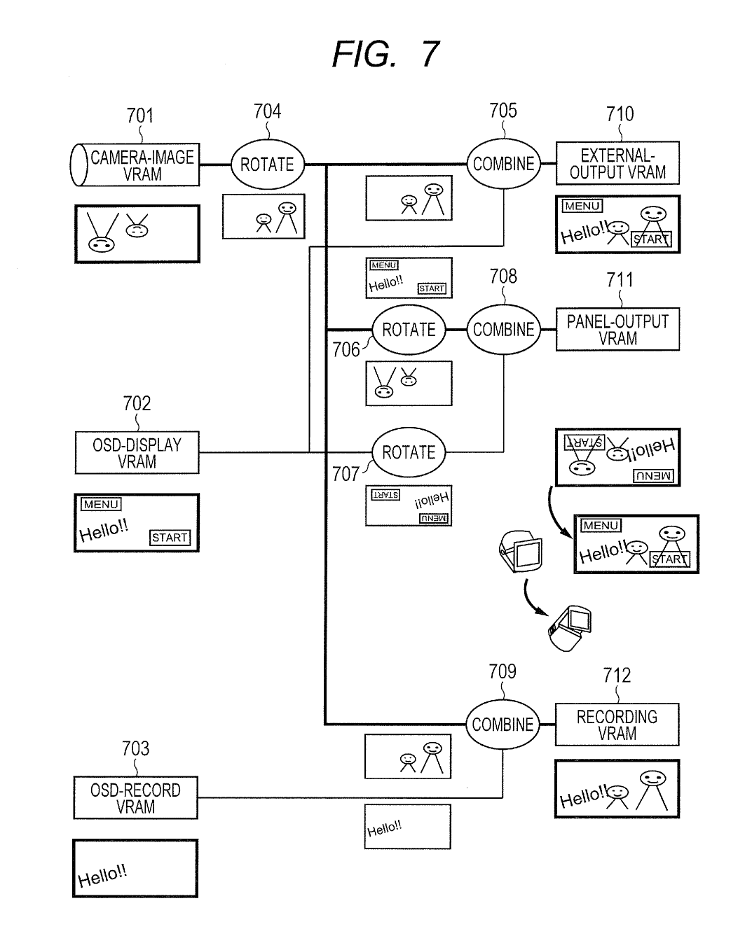

FIG. 7 illustrates a schematic block diagram of a construction of an image processing system of the camera image and the OSD data corresponding to the operation described with reference to FIG. 5. Simple contents of the image in each unit in the case where the characters of “Hello!!” are drawn by the touch drawing function are additionally shown. A camera-image VRAM 701, an OSD-display VRAM 702, an OSD-record VRAM 703, an external-output VRAM 710, a panel-output VRAM 711, and a recording VRAM 712 are held in the temporary storage unit 103.

The camera-image VRAM 701 is a VRAM in which the image data which is picked up by the camera unit 101 and is converted into the digital data by the image processing unit 102 is stored (drawn). The OSD-display VRAM 702 is a VRAM in which the OSD data to be superimposed to the image for displaying to the LCD panel 112 or the image for outputting to the outside is stored. The combination data of the display OSD data and the recording OSD data which are combined by the OSD-combine unit 504 is stored in the OSD-display VRAM 702. The OSD-record VRAM 703 is a VRAM in which the recording OSD data which is input by the touch drawing function is stored.

When the autorotation function is ON and the main-body orientation detection unit 110 indicates the inverse state, a rotation unit 704 rotates the image data from the camera-image VRAM 701 by 180 degrees. Unless otherwise, the image data is passed through.

A combine unit 705 combines the image data which is output from the rotation unit 704 and the image data from the OSD-display VRAM 702 and writes combined image data into the external-output VRAM 710. The image data written in the external-output VRAM 710 is output to an external output apparatus of the standard such as HDMI (registered trademark), composite, or the like.

A rotation unit 706 rotates the image data from the rotation unit 704 by 180 degrees. If the image data has already been rotated by 180 degrees in the rotation unit 704, the image data is rotated by 360 degrees in total. Output image data of the rotation unit 706 becomes the image data itself from the camera-image VRAM 701 or the camera image data which is not rotated.

When the autorotation function is ON and the main-body orientation detection unit 110 indicates the inverse state, a rotation unit 707 rotates the image data from the OSD-display VRAM 702 by 180 degrees. Unless otherwise, the image data is passed through.

A combine unit 708 combines the image data from the rotation unit 706 and the image data from the rotation unit 707 and writes combined image data into the panel-output VRAM 711. When the autorotation function is ON and the main-body orientation detection unit 110 indicates the inverse state, the orientation of the object in the camera image and the orientation of the OSD are opposite to the vertical direction of the LCD panel 112. However, since the camera 100 is held upside-down, when the LCD panel 112 is viewed from the user, the orientation of the image which is displayed to the LCD panel 112 is a correct orientation according to the actual object.

A combine unit 709 combines the image data from the rotation unit 704 and the image data from the OSD-record VRAM 703 and writes combined image data into the recording VRAM 712. The encoder decoder unit 104 encodes the image data written in the recording VRAM 712 and records a moving image file or still image file constructed by the encoded image data into the moving image storing unit 105.

The output image data from the rotation unit 704 is output as it is to an external apparatus and can be also recorded into a recording medium on the external apparatus side. In this case, the recorded image is an image which has already been rotated in accordance with the attitude and, when the image which is recorded into the recording medium on the external apparatus side is reproduced, even if the rotation processing is not executed, it can be viewed in the correct orientation.

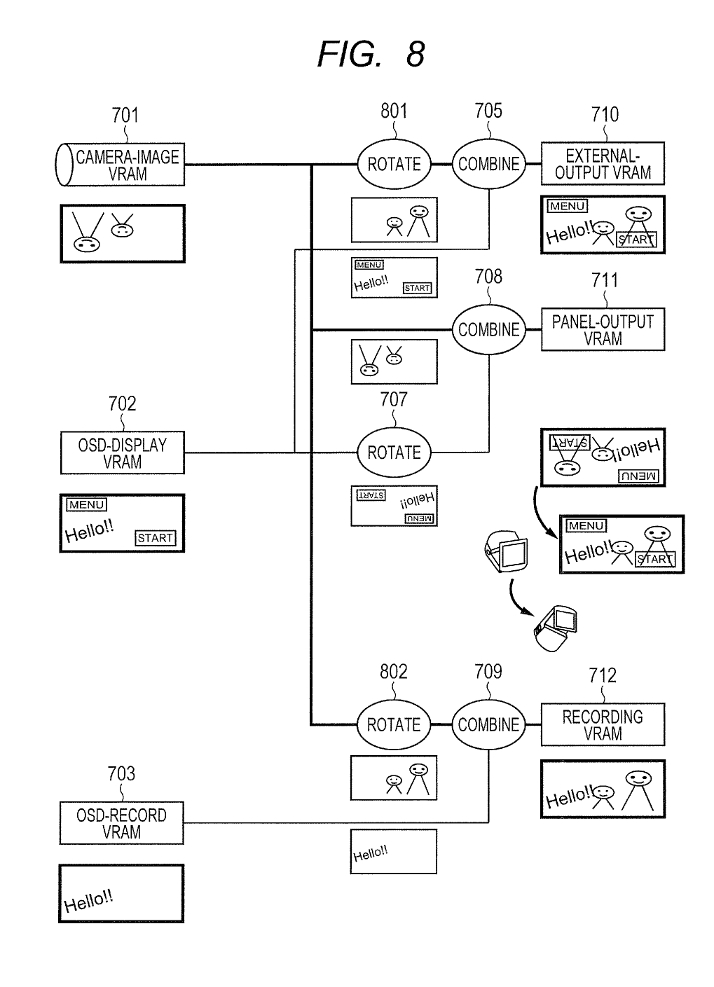

Since the angle of the rotation which is performed by the rotation units 704 and 706 is equal to 360 degrees in total, substantially the same result as that in the case where the image data is not rotated at all is obtained. From such a viewpoint, the construction illustrated in FIG. 7 can be changed to a construction in which an overlap rotation is avoided as illustrated in FIG. 8. In the construction illustrated in FIG. 8, rotation units 801 and 802 are provided in place of the rotation units 704 and 706. The rotation unit 801 rotates the image data from the camera-image VRAM by 180 degrees or passes it through under conditions similar to those in the rotation units 704 and 706 and inputs to the combine unit 705. The rotation unit 802 rotates the image data from the camera-image VRAM by 180 degrees or passes it through under conditions similar to those in the rotation units 704 and 706 and inputs to the combine unit 709.

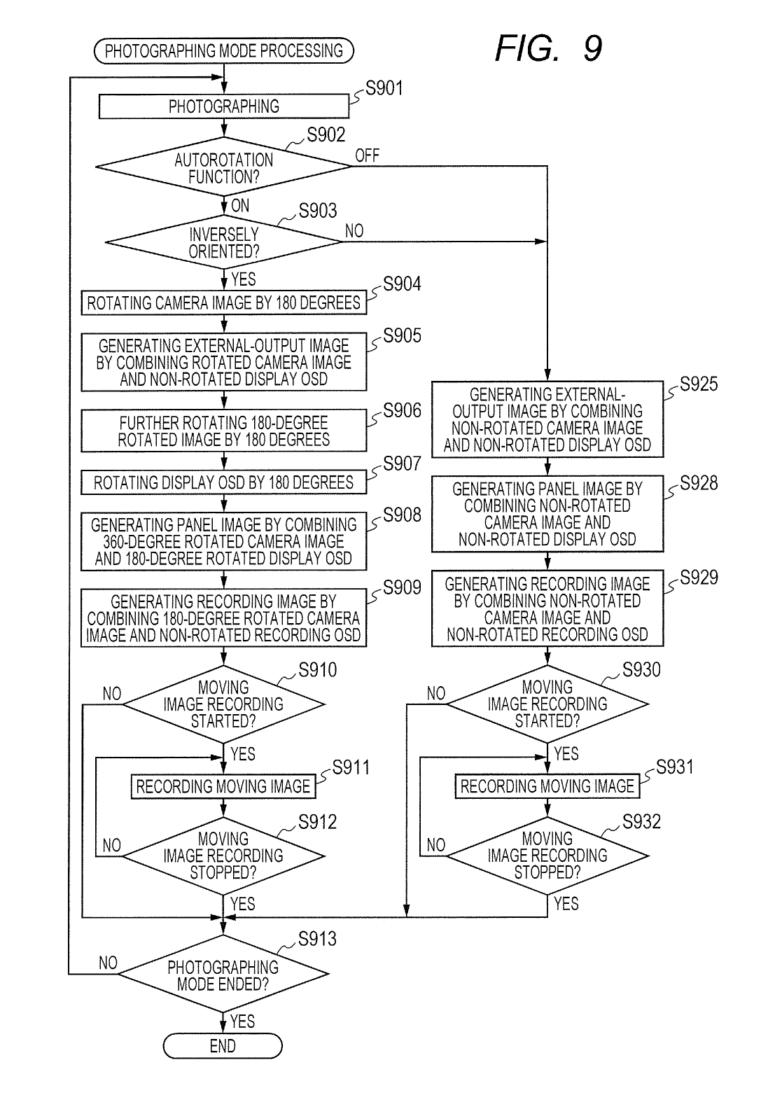

FIG. 9 illustrates a flowchart for a processing in the photographing mode to realize the foregoing processing. This processing is realized by a method whereby the CPU 107 reads out a program from the program and data storing unit 106 and executes. When the camera 100 is set into the photographing mode and is activated, the CPU 107 starts the processing illustrated in FIG. 9.

In S901, the CPU 107 starts the photographing in the camera unit 101. In this instance, the photographing is performed to obtain a monitor image (what is called a live-view image or a through image) in the photographing standby state. The camera image photographed by the camera unit 101 is subjected to various kinds of image processings in the image processing unit 102 and is stored into the camera-image VRAM 701 in the temporary storage unit 103. The camera image which is stored into the camera-image VRAM 701 is successively updated at a predetermined frame rate so as to be visually confirmed as a moving image.

In S902, the CPU 107 discriminates whether or not the autorotation function is ON. ON/OFF of the autorotation function is set in a setting menu display screen on the basis of the user's operation. Information indicating to which one of ON and OFF the autorotation function is set is recorded in the program and data storing unit 106 serving as a nonvolatile memory. By referring to the program and data storing unit 106, the CPU 107 makes the discrimination of S902. When the autorotation function is ON, the CPU 107 advances to S903. If NO, S925 follows. In S903, on the basis of the output of the main-body orientation detection unit 110, the CPU 107 discriminates whether or not the camera 100 is inversely oriented (upside-down) for the gravitational direction. If the camera 100 is inversely oriented, the CPU 107 advances to S904. If NO, S925 follows.

The processings of steps S904 to S909 correspond to the processings described with respect to the blocks 704 to 710 illustrated in FIG. 7.

In S904, the CPU 107 (rotation unit 704) rotates the camera image stored in the camera-image VRAM 701 by 180 degrees. A processing for vertically and horizontally inverting may be executed in place of the processing for rotating the camera image by 180 degrees. As a result, the same image is obtained. The processing for rotating the camera image by 180 degrees may be replaced by the processing for vertically and horizontally inverting hereinbelow.

In S905, the CPU 107 (combine unit 705) combines the OSD data (combined data of the display OSD data and the recording OSD data) drawn in the OSD-display VRAM 702 to the camera image data rotated by 180 degrees in S904 and generates external-output image data. At this time, the OSD data drawn in the OSD-display VRAM 702 is data which is not rotated. The CPU 107 (combine unit 705) stores the generated external-output image data into the external-output VRAM 710. If an external apparatus is connected to the external output unit 113, the external-output image data stored in the external-output VRAM 710 is output to the external apparatus through the external output unit 113. If the external apparatus is not connected to the external output unit 113 and if such a construction that the external output unit 113 is not provided is used, the processing of S905 and a processing of S925, which will be described hereinafter, can be omitted.

In S906, the CPU 107 (rotation unit 706) further rotates the camera image data which is rotated by 180 degrees in S904 by 180 degrees. As a result, the camera image data becomes the data which is rotated by 360 degrees and is the same as the camera image data which is not rotated. In the case of the construction illustrated in FIG. 8, the processing of S906 is not executed.

In S907, the CPU 107 (rotation unit 707) rotates the OSD data (combined data of the display OSD data and the recording OSD data) drawn in the OSD-display VRAM 702 by 180 degrees.

In S908, the CPU 107 (combine unit 708) superimposes and combines the OSD data rotated in S907 to the camera image rotated in S906 (as a result, the camera image rotated by 360 degrees). The panel image data generated by the above combining processing is written into the panel-output VRAM 711. The display control unit 111 reads out the panel image data stored in the panel-output VRAM 711 and supplies to the LCD panel 112. Thus, the image of the panel image data stored in the panel-output VRAM 711 is displayed to the LCD panel 112. The panel image data which is stored in the panel-output VRAM 711 is, for example, the image data 510 described in FIG. 5 and its image is displayed as illustrated as an example in FIG. 5.

In S909, the CPU 107 (combine unit 709) superimposes and combines, without rotating, the OSD data (only the recording OSD data) drawn in the OSD-record VRAM 703 to the camera image rotated by 180 degrees in S904. The obtained image data for recording (recording image data) is stored in the recording VRAM 712. The recording image data which is stored in the recording VRAM 712 is, for example, the image data 511 described in FIG. 5. It is also possible to construct in such a manner that the processing of S909 is not executed in a state where a moving image recording start is not instructed and the moving image is not stored in the moving image storing unit 105.

In S910, the CPU 107 discriminates whether or not a moving image recording start button included in the operation key 108 is depressed and the moving image recording start is instructed. If it is determined that the moving image recording start is instructed, the CPU 107 advances to S911. If NO, S913 follows.

In S911, the CPU 107 instructs the encoder decoder unit 104 so as to encode the recording image data which is stored in the recording VRAM 712. The encoder decoder unit 104 stores the encoded image data obtained by the encoding into the moving image storing unit 105 as a moving image file of a predetermined format.

Also during the moving image recording, the CPU 107 executes the processings of S904 to S908 and the image data is output to each of the external output unit 113 and the LCD panel 112. However, for a period of time during which the moving image is being recorded, the processing of S903 is not executed. Therefore, when the moving image recording is started, the orientation of each image is maintained to the orientation according to the attitude of the camera 100 at a point of time of the moving image recording start until the moving image recording is stopped. By this method, for example, such a situation that the orientation of the recorded moving image is switched by 180 degrees on the way of the recording and the image is difficult to be viewed is prevented. While the recording image which is stored into the recording VRAM 712 is held to the orientation according to the attitude of the camera 100 at the point of time of the moving image recording start, the image which is stored into the external-output VRAM 710 and/or the panel-output VRAM 711 may be changed in accordance with a change in attitude of the camera 100.

In S912, the CPU 107 discriminates whether or not the moving image recording start button included in the operation key 108 is depressed and a moving image recording stop is instructed. If it is determined that the moving image recording stop is not instructed, the CPU 107 returns to S911 and continuously executes the moving image recording. If the moving image recording stop is instructed, the CPU 107 executes a stop processing such as a closing processing of the moving image file according to the recording stop or the like and advances to S913.

In S913, the CPU 107 discriminates whether or not there is a photographing mode finishing event. As a photographing mode finishing event, there are an event to shift to another moving image mode such as a reproducing mode or the like based on the user's operation, an event to turn off a power source, and the like. When there is not the photographing mode finishing event, the CPU 107 returns to S901 and repeats the processing. When there is the photographing mode finishing event, the CPU 107 finishes the photographing mode processing illustrated in FIG. 9.

In response to a still image photographing instruction, in place of S911 and S912, the encoder decoder unit 104 encodes the recording image data, as a still image, which is stored in the recording VRAM 712 and stores as a still image file into the moving image storing unit 105 or another storing unit.

When the camera 100 is not in the inverse state, that is, the camera 100 is in the normal attitude, the CPU 107 executes the processings of S925 and subsequent steps.

In S925, the CPU 107 (combine unit) superimposes and combines the OSD data (the combined data of the display OSD data and the recording OSD data) in the OSD-display VRAM 702 to the camera image data which is output from the camera-image VRAM 701 and is not rotated. The obtained combined image data is stored, as external-output image data, into the external-output VRAM 710.

In S928, the CPU 107 (combine unit) superimposes and combines the OSD data (the combined data of the display OSD data and the recording OSD data) in the OSD-display VRAM 702 to the camera image data which is output from the camera-image VRAM 701 and is not rotated. The obtained combined image data is stored, as panel-image data, into the panel-output VRAM 711.

In S929, the CPU 107 (combine unit) superimposes and combines the OSD data (only the recording OSD data) in the OSD-record VRAM 703 to the camera image data which is output from the camera-image VRAM 701 and is not rotated. The obtained combined image data is stored, as recording image data, into the recording VRAM 712. It is also possible to construct in such a manner that the processing of S929 is not executed in a state where the moving image recording start is not instructed and no moving image is stored in the moving image storing unit 105.

Since processings of S930 to S932 are substantially the same as those of S910 to S912, their description is omitted here.

As mentioned above, by switching the display orientation control of the camera image, display OSD, and recording OSD in accordance with the ON/OFF state of the autorotation function and the main body orientation, the image data which is suitable for each of the external-output display, the panel display, and the image recording can be generated.

FIG. 10 is a flowchart illustrating the drawing control processing of the recording OSD which is executed by the CPU 107 when a touch drawing input is received from the user. This processing is realized by a method whereby the CPU 107 reads out the program from the program and data storing unit 106 and executes.

In S1001, the CPU 107 discriminates whether or not the event is received from the user. If the event is received, the CPU 107 advances to S1002. If the event is not received, the CPU 107 repetitively executes the processing of S1001.

In S1002, the CPU 107 discriminates whether or not the event received in S1001 is the touch drawing finishing event. If the event is the touch drawing finishing event, the CPU 107 finishes the touch drawing. If the event is not the touch drawing finishing event, the CPU 107 advances to S1003.

In S1003, the CPU 107 discriminates whether or not the event received in S1001 is the touch drawing event. The touch drawing event is an event for issuing the OSD data for superimposing such as free-hand input/stamp input as a part of the touch drawing function. If the received event is not the touch drawing event, the CPU 107 advances to S1001. If the event is the touch drawing event, the CPU 107 advances to S1004.

In S1004, the CPU 107 discriminates whether or not the autorotation function is ON. If the autorotation function is ON, the CPU 107 advances to S1005. If the autorotation function is OFF, the CPU 107 advances to S1007. The user can set ON/OFF of the autorotation function from the menu screen.

In S1005, the CPU 107 discriminates whether or not the orientation of the main body of the camera 100 is an inverse state. If it is the inverse state (state illustrated in FIG. 3C), the CPU 107 advances to S1006. If it is the normal state (state illustrated in FIG. 3A), the CPU 107 advances to S1007.

In S1006, the CPU 107 (coordinate-transform unit 512) executes a coordinate-transform processing for rotating the touch coordinates by 180 degrees. Specifically speaking, the CPU 107 executes a calculation of “a touch coordinate width in the horizontal direction—an X coordinate which is obtained from the touch panel” with respect to the X coordinate and a calculation of “a touch coordinate width in the vertical direction—a Y coordinate which is obtained from the touch panel” with respect to the Y coordinate. That is, the CPU 107 executes what is called an XY coordinates inversion processing. After completion of the processing of S1006, the CPU 107 advances to S1007.

In S1007, the CPU 107 draws an object of a drawing target into the OSD-record VRAM 703. Specifically speaking, the CPU 107 draws the object to the X and Y coordinate positions of the touched position (If NO in S1004 and S1005). If the coordinate-transform processing is executed in S1006, the CPU 107 draws the object to the X and Y coordinate positions (in the case of S1006) where the touched coordinate position is coordinate-transformed. The object of the drawing target is, for example, a rectangle or a circle of a specific size in the case of free-hand and is a stamp of a specific shape in the case of stamp input. If the attitude detection is ON and the orientation of the main body of the camera 100 is the inverse state, the object is drawn at the position rotated by 180 degrees by the processing of S1006.

The image data obtained by combining the image data drawn in the OSD-record VRAM 703 and the display OSD data is stored into the OSD-display VRAM.

As described above, even if the camera main body is set into the inverse state, the display OSD which is displayed on the LCD panel is in the correct orientation which is not contradictory when viewed from the user. The recording image to which the recording OSD data is superimposed is recorded in a manner similar to that in the case where the image is displayed on the LCD panel. Consequently, even when the camera main body is set into the inverse state, while maintaining the operability, the photographed image which is intended by the user and the OSD item such as a touch drawing or the like can be recorded.

Although the main-body orientation detection unit 110 for automatically detecting the vertical attitude of the main body is provided in the embodiment, the user may manually set the vertical state.

Although the embodiment has been described on the assumption that the image data is rotated by 180 degrees, as a method of rotating it by 180 degrees, the image data may be vertically inverted and then horizontally inverting or a read-out start position in the memory may be changed.

### Second Embodiment

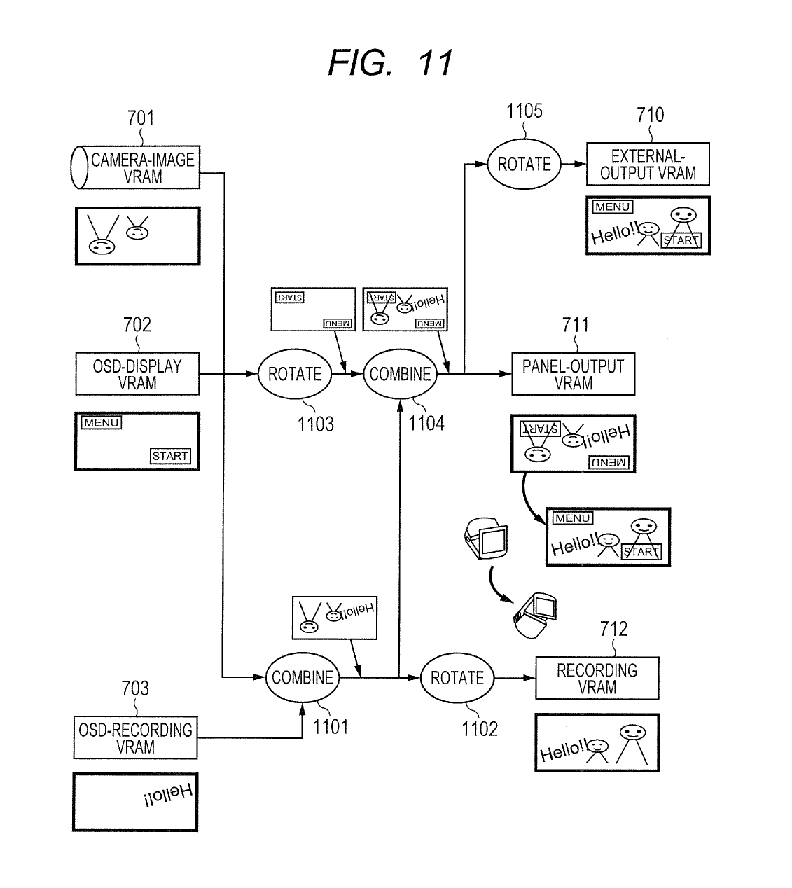

FIG. 11 illustrates a block diagram of a schematic construction of an example of an alternative construction of FIG. 7. Substantially the same component elements as those in FIG. 7 are denoted with the same reference numerals. The processing in each functional block is executed under control of the CPU 107.

In the construction illustrated in FIG. 11, unlike FIG. 7, it is assumed that the coordinate-transform processing in S1006 is not executed but the recording OSD data is drawn in the OSD-record VRAM 703 irrespective of the attitude of the camera 100. Therefore, when the camera 100 is in the inverse attitude, the recording OSD data is inversely drawn when the normal attitude is set to a reference. Only the non-rotated display OSD data which is read out is drawn in the OSD-display VRAM 702 and, at this stage, the recording OSD data is not superimposed.

A combine unit 1101 (CPU 107) combines the recording OSD data drawn in the OSD-record VRAM 703 to the non-rotated photographed image data which is output from the camera-image VRAM 701. A rotation unit 1102 (CPU 107) rotates output image data from the combine unit 1101 in accordance with the attitude which is detected by the main-body orientation detection unit 110. That is, in the case of the normal attitude, the rotation unit 1102 does not rotate, and in the case of the inverse attitude, the rotation unit 1102 rotates the output image data by 180 degrees. The image data processed in the rotation unit 1102 is stored into the recording VRAM 712, encoded, and recorded into the moving image storing unit 105.

A rotation unit 1103 (CPU 107) rotates the image data which is output from the OSD-display VRAM 702 in accordance with the attitude which is detected by the main-body orientation detection unit 110. That is, in the case of the normal attitude, the rotation unit 1103 does not rotate, and in the case of the inverse attitude, the rotation unit 1103 rotates the output image data by 180 degrees. A combine unit 1104 (CPU 107) combines the image data which is processed by the rotation unit 1103 and the image data combined by the combine unit 1101, stores the image data as a combining result into the panel-output VRAM 711 and outputs to a rotation unit 1105. Thus, the display OSD item which is inverse with respect to the normal attitude reference, the photographed image, and the recording OSD item are displayed in the panel-output VRAM 711. Since the user inversely holds the camera 100 and watches the image displayed to the LCD panel 112, the user can watch the image displayed to the LCD panel 112 in the normal orientation instead of the inverse orientation.

The rotation unit 1105 (CPU 107) rotates the image data processed by the combine unit 1104 in accordance with the attitude which is detected by the main-body orientation detection unit 110 and outputs to the external-output VRAM 710. That is, in the case of the normal attitude, the rotation unit 1105 does not rotate, and in the case of the inverse attitude, the rotation unit 1105 rotates the output image data by 180 degrees.

When the autorotation function is ON and the main body is in the inverse attitude, the processings described with reference to FIGS. 7, 8, and 11 are executed as follows.

An image photographed by the camera unit 101 is displayed as it is to the LCD panel 112. In the construction illustrated in FIG. 7, the image is rotated by 360 degrees and displayed. In the construction illustrated in FIG. 8, the non-rotated image is displayed.

On the LCD panel 112, the recording OSD item is displayed in the same orientation as that of a trace drawn to the touch panel 109. That is, in the constructions illustrated in FIGS. 7 and 8, the coordinate-transform (equivalent to the 180-degree rotation) is executed twice so as to vertically and horizontally invert the coordinates of the touched position. Thus, the above processing is equivalent to the 360-degree rotation and the recording OSD item of the same orientation as that of the touched coordinates is displayed. In the construction illustrated in FIG. 11, for the touch panel 109, the touched coordinates are not transformed but the image data in the OSD-display VRAM 702 including the recording OSD drawn on the basis of the touched coordinates is displayed without being rotated.

The display OSD item stored in the program and data storing unit 106 is rotated by 180 degrees and displayed on the LCD panel 112.

Although the image photographed by the camera unit 101 and the recording OSD item are combined and recorded into the moving image storing unit 105, the image photographed by the camera unit 101 is recorded in the orientation which is rotated by 180 degrees and the recording OSD item is recorded in the 180-degree rotated orientation and position. In the combined image which is recorded as mentioned above, there is no dissidence of the orientations of the handwritten recording object which is drawn by the touch input and the photographed image, and the same image as the image which is watched when the user performs the touch input is recorded. That is, even in the attitude in which the camera is inversely held, the photographed image and the OSD items such as touch drawing and the like can be recorded in the desired orientation while maintaining the operability.

Although the foregoing embodiment is described on the assumption that the recording OSD item is the OSD item drawn by the input of the touch position to the touch panel, it is not limited to such an example but may be an OSD item which is drawn on the basis of the position input onto the display screen. For example, it may be an OSD item which is drawn on the basis of the position input onto the display screen by moving a position of a cursor by using a mouse, a touch pad, a joy stick, or the like.

The control of the CPU 107 may be made by one hardware or the control of the whole apparatus may be made by sharing the processings by a plurality of hardware.

Although the embodiments have been described above with respect to the case where the invention is applied to the video camera as an example, the invention is not limited to such an example but can be applied to any apparatus having the imaging unit and the touch drawing function. For example, the invention can be applied to a personal computer, a PDA, a portable phone terminal, or the like.

### Other Embodiments

Embodiments of the present invention can also be realized by a computer of a system or apparatus that reads out and executes computer-executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer-executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disk (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-157007, filed on Jul. 29, 2013, which is hereby incorporated by reference herein in its entirety.

What is claimed is:

1. An imaging apparatus comprising:
an imaging unit;
a display unit;
a position input unit configured to input a position to the display unit;
a drawing unit configured to draw a recording object on the basis of the position on a screen of the display unit input by the position input unit;
an attitude detection unit configured to detect an attitude of the imaging apparatus; and
a control unit configured to control in such a manner that when the attitude detection unit detects an inverse attitude of the imaging apparatus, an image photographed by the imaging unit and the recording object which is input by the position input unit are displayed to the display unit in a same orientation, and the image photographed by the imaging unit and the recording object which is input by the position input unit are combined and recorded to a recording medium so that the combined image and object are oriented inversely each other.

2. An apparatus according to claim 1, further comprising a storing unit configured to store a display item, and
wherein the control unit controls in such a manner that when the attitude detection unit detects the inverse attitude of the imaging apparatus, the image photographed by the imaging unit and the recording object which is input by the position input unit are displayed to the display unit in the same orientation, the display item is also displayed in the orientation opposite to the orientation in which the display item is stored in the storing unit, and the image photographed by the imaging unit and the recording object which is input by the position input unit are combined and recorded to the recording medium so that the combined image and object are oriented inversely each other.

3. An apparatus according to claim 1, wherein the control unit controls the display to the display unit and the recording to the recording medium in accordance with the attitude of the imaging apparatus at the time of start of a moving image recording and maintains the control.

4. An apparatus according to claim 2, further comprising a setting unit configured to set ON/OFF of an autorotation function, and
wherein the control unit controls in such a manner that when the autorotation function is OFF and the attitude detection unit detects the inverse attitude of the imaging apparatus, the image photographed by the imaging unit and the recording object which is input by the position input unit are displayed to the display unit in the same orientation, the display item is also displayed in the orientation in which the display item is stored in the storing unit, and the image photographed by the imaging unit and the recording object which is input by the position input unit are combined and recorded to the recording medium so that the combined image and object are originally oriented.

5. An apparatus according to claim 2, wherein the control unit controls in such a manner that when the attitude detection unit detects a normal attitude of the imaging apparatus, the image photographed by the imaging unit, the recording object which is input by the position input unit, and the display item are displayed to the display unit in the orientation in which the display item is stored in the storing unit, and the image photographed by the imaging unit and the recording object which is input by the position input unit are combined and recorded to the recording medium so that the combined image and object are originally oriented.

6. An apparatus according to claim 2, further comprising an external output unit configured to, when the attitude detection unit detects the inverse attitude of the imaging apparatus, combine an image of an orientation opposite to that of the image photographed by the imaging unit, an object of an orientation opposite to that of the recording object which is input by the position input unit, and the display item of an orientation in which the display item is stored in the storing unit are combined and externally output a combined result.

7. An apparatus according to claim 1, wherein the position input unit is a touch panel.

8. An apparatus according to claim 1, wherein the recording object is a handwritten object which is drawn in accordance with a trace of the input position.

9. An apparatus according to claim 1, wherein the control unit controls in such a manner that when the attitude detection unit detects the inverse attitude of the imaging apparatus, the recording object which is drawn by coordinate-transforming the position input by the position input unit by inverting vertically and horizontally is combined to an image in which the image photographed by the imaging unit is rotated by 180 degrees, and the combined image and object are recorded in the recording medium.

10. An apparatus according to claim 2, wherein the control unit controls in such a manner that when the attitude detection unit detects the inverse attitude of the imaging apparatus, an image in which an image obtained by rotating the image photographed by the imaging unit by 180 degrees is further rotated by 180 degrees is combined to an image in which an image obtained by combining the display item and the recording object which is drawn by coordinate-transforming the position input by the position input unit by vertically and horizontally inverting is rotated by 180 degrees, and the combined images are displayed to the display unit.

11. An apparatus according to claim 2, wherein the control unit controls in such a manner that when the attitude detection unit detects the inverse attitude of the imaging apparatus, an image obtained by combining the display item and the recording object which is drawn by coordinate-transforming the position input by the position input unit by vertically and horizontally inverting and an image obtained by rotating the image photographed by the imaging unit by 180 degrees are combined and output to an outside.

12. An imaging apparatus comprising:
an imaging unit;
a display unit;
a position input unit configured to input a position to the display unit;
a drawing unit configured to draw a recording object on the basis of the position on a screen of the display unit input by the position input unit;
an attitude detection unit configured to detect an attitude of the imaging apparatus; and
a control unit configured to control in such a manner that when the attitude detection unit detects an inverse attitude of the imaging apparatus, an image photographed by the imaging unit and the recording object which is input by the position input unit are displayed to the display unit in a same orientation, and a combined image obtained by combining the image photographed by the imaging unit and the recording object which is input by the position input unit is recorded to a recording medium in an inverse orientation.

13. An apparatus according to claim 12, further comprising a storing unit configured to store a display item, and
wherein the control unit controls in such a manner that when the attitude detection unit detects the inverse attitude of the imaging apparatus, the image photographed by the imaging unit and the recording object which is input by the position input unit are displayed to the display unit in the same orientation, the display item is also displayed in the orientation opposite to the orientation in which the display item is stored in the storing unit, and the combined image obtained by combining the image photographed by the imaging unit and the recording object which is input by the position input unit is recorded to the recording medium in the inverse orientation.

14. An imaging apparatus comprising:
an imaging unit;
a display unit;
a position input unit configured to input a position to the display unit;
an attitude detection unit configured to detect an attitude of the imaging apparatus;
a drawing unit configured to draw a recording object on the basis of a position which is transformed from the position on a screen of the display unit input by the position input unit by vertically and horizontally inverting, when the attitude detection unit detects an inverse attitude of the imaging apparatus; and
a control unit configured to control in such a manner that when the attitude detection unit detects the inverse attitude of the imaging apparatus, an image photographed by the imaging unit and an object in which the recording object which is input by the position input unit is transformed in a different orientation are displayed to the display unit, and an image in which the image photographed by the imaging unit is transformed in the different orientation and the recording object which is input by the position input unit are combined and recorded to a recording medium.

15. A control method of an imaging apparatus having
an imaging unit,
a display unit,
a position input unit configured to input a position to the display unit,
a drawing unit configured to draw a recording object on the basis of the position on a screen of the display unit input by the position input unit, and
an attitude detection unit configured to detect an attitude,
comprising:
an attitude detection step of detecting the attitude of the imaging apparatus by the attitude detection unit; and
a control step of controlling in such a manner that when an inverse attitude of the imaging apparatus is detected in the attitude detection step, an image photographed by the imaging unit and the recording object which is input by the position input unit are displayed to the display unit in a same orientation, and the image photographed by the imaging unit and the recording object which is input by the position input unit are combined and recorded to a recording medium so that the combined image and object are oriented inversely each other.

16. A control method of an imaging apparatus having
an imaging unit,
a display unit,
a position input unit configured to input a position to the display unit,
a drawing unit configured to draw a recording object on the basis of the position on a screen of the display unit input by the position input unit, and
an attitude detection unit configured to detect an attitude,
comprising:
an attitude detection step of detecting the attitude of the imaging apparatus by the attitude detection unit; and
a control step of controlling in such a manner that when an inverse attitude of the imaging apparatus is detected in the attitude detection step, an image photographed by the imaging unit and the recording object which is input by the position input unit are displayed to the display unit in a same orientation, and a combined image obtained by combining the image photographed by the imaging unit and the recording object which is input by the position input unit is recorded to a recording medium in an inverse orientation.

17. A control method of an imaging apparatus having
an imaging unit,
a display unit,
a position input unit configured to input a position to the display unit,
a drawing unit configured to draw a recording object on the basis of the position on a screen of the display unit input by the position input unit, and
an attitude detection unit configured to detect an attitude,
comprising:
an attitude detection step of detecting the attitude of the imaging apparatus by the attitude detection unit;
a drawing step of drawing a recording object on the basis of a position which is transformed from the position on a screen of the display unit input by the position input unit by vertically and horizontally inverting, when an inverse attitude of the imaging apparatus is detected in the attitude detection step; and
a control step of controlling in such a manner that when the inverse attitude of the imaging apparatus is detected in the attitude detection step, an image photographed by the imaging unit and an object in which the recording object which is input by the position input unit is transformed in a different orientation are displayed to the display unit, and an image in which the image photographed by the imaging unit is transformed in the different orientation and the recording object which is input by the position input unit are combined and recorded to a recording medium.

18. A non-transitory computer-readable storage medium storing a program for causing a computer to function as each unit of the imaging apparatus according to claim 1.
